(19) United States
(12) Patent Application Publication
(10) Pub. No.: US 2007/0288486 A1
(43) Pub. Date: Dec. 13, 2007

(54) Methods and system for providing information

(76) Inventor: Jonathan Sugihara, San Francisco, CA (US)

Correspondence Address: TRASK BRITT, P.O. BOX 2550, SALT LAKE CITY, UT, 84110, US

(21) Appl. No.: 11/796,548

(22) Filed: Apr. 26, 2007

Related U.S. Application Data
(60) Provisional application No. 60/795,023, filed on Apr. 26, 2006.

(51) Int. Cl. G06F 17/30

(52) U.S. Cl. 707/10; 455/410; 707/E17.032

(57) ABSTRACT

The present invention provides a method for enabling requests for information as well as methods and a system for providing, storing and accessing information via an online database. In one embodiment, the present invention relates to a method for providing information that includes providing a code in a media application, receiving the code transmitted by a user, processing the code, and providing a user with content based on the code. In another embodiment, the present invention relates to a system for providing information that includes a registered user, a database and a server enabling the user to access the database. Another embodiment of the present invention relates to a method of providing information that includes displaying a first code using a visual media, receiving the first code, processing the first code and transmitting a second code wherein said second code may be used to access information related to the visual media.

### CROSS-REFERENCE TO RELATED APPLICATIONS

Under the provisions of 35 U.S.C. §119(e), priority is claimed from Provisional patent application 60/795,023 filed on Apr. 26, 2006, the disclosure of which is hereby incorporated herein, in its entirety, by this reference.

### FIELD OF THE INVENTION

The present invention relates generally to information networks and, more particularly, to methods and systems for effectively providing individuals with access to information using a computer-based system. More specifically, the present invention relates to methods and systems for “tagging” items shown in the media (e.g., on television, in movies, on printed advertisements, etc.) with identifiers that may be used by individuals to obtain additional information about the “tagged” items.

### BACKGROUND OF THE INVENTION

Through the immediate interface of the Internet, consumers may discover, access, and interact with content. When away from their personal computer (PC), however, interactivity is difficult and limited. Although mobile internet services are available to those with properly equipped telephones or personal digital assistants (PDAs), mobile internet services are nascent, expensive and have challenging input and display mechanisms.

Currently, traditional media and content providers lack a consumer-friendly mechanism to engage their audience via their offline media outlets. Content providers have traditionally relied on broad promotion instead of interaction. Content providers have a strong need for a mechanism to allow consumers to transition from a traditional offline medium to an engaging, interactive, rich and viral online experience. A web community of users interacting with content extends the potential of viral promotion.

Moreover, the effectiveness of offline advertising techniques such as print promotion and television advertising are difficult to gauge. The current mechanism of evaluating performance is to calculate viewer impression using print circulation numbers or television rating systems such as Neilsen. However, calculating the engagement of a viewer from these statistics may be difficult, if not impossible.

Accordingly, a means of providing information that readily enables a user to request, store, access and maintain such information is desirable.

### SUMMARY OF THE INVENTION

The present invention include methods for enabling requests for information, as well as methods and systems for providing, storing and accessing information via user-accessible (e.g., Internet accessible, or “online”) databases.

In some embodiments of the present invention, a method of enabling requests for information is provided. A code that enables a user to request information may be presented to potential users (e.g., through a media application, including, but not limited to visual, audio, and verbal media applications, from one person to another, or otherwise). As used herein, the term “media” includes conventional media, as well as other means or methods by which codes may be disseminated (e.g., person-to-person propagation, etc.). The method may include receiving a code associated with information, retrieving information associated with the code, storing the code and providing a user with access to the stored code. A code may be transmitted, from a point of transmission (which may be at or near the location at which the code is perceived) regardless of whether the user has access to additional information associated with the code (e.g., Internet access), to a server by a user who has subscribed to the system, or a “registered user,” and, in some embodiments, by unregistered users, using a communication device. The server is connected to a network and a database, which may be configured, or programmed, to save or store the code, as well as to provide access to information associated with the code. The server recognizes the code transmitted by the user and may retrieve information associated with the code from the database. The information may enable the user to access content, or information, related to the code. The server may further store the code in storage allocated on the database to a registered user. Access to the storage allocated to the registered user may be provided enabling the user to access stored codes.

By way of non-limiting example, during a television program, an alphabetic, numeric, or alphanumeric code may be displayed in association with certain elements shown in the television program (e.g., clothing, furniture, food, a scene, etc.). Input instructions (e.g. a text number) for “saving” the code for later online access may also be provided. Use of the displayed code and optional input instructions may enable a request for information with an item with which the code is associated. As an example, the code may be sent, as a text message, to a central server. Once the individual who sent and saved or stored one or more codes is able to access the network or database (e.g., through the Internet), the code and any associated information may be accessed.

Another embodiment of the invention relates to a method for providing information that includes providing a code in a media application, receiving the code transmitted by a user, saving, storing, or processing the code. The content may be stored on a database that may be accessed by a user who previously transmitted and, thus, saved or stored the code. The code may be processed to retrieve content related to the media application displaying the code. Alternatively, the code may provide a link to an external server or database. The system may be accessed by the user via a communication device, such as a computer or other electronic device that communicates with the server via the Internet. Once access to the system has been obtained, the user may access content associated with each saved, stored, or processed code.

In another aspect, the present invention includes systems for providing information to users, including codes available through media, as well as a database and a server enabling a user to access the database using one or more codes. In some embodiments, the user may access the database through a user-specific account. To obtain information, the user may access network-based storage that contains a set of codes that enable the user to retrieve information associated with the code via an interstitial page. The database stores interstitial pages associated with codes as well as network-based storage allocated to the user. The server is connected to the database and allocates network-based storage to the user. The server receives codes transmitted by the user and stores the codes in the network-based storage.

In another embodiment, the present invention include a method of providing information that includes displaying or verbally presenting a code using an audio or visual media application, receiving the code, processing the code and transmitting another code, which code may be used to access information related to the media.

### BRIEF DESCRIPTION OF THE SEVERAL VIEWS OF THE DRAWINGS

While the specification concludes with claims particularly pointing out and distinctly claiming that which is regarded as the present invention, the advantages of the embodiments of the invention may be more readily ascertained from the following description of embodiments of the invention when read in conjunction with the accompanying drawings in which:

FIGS. 1-3 illustrate interaction of the components in various embodiment of the present invention; and

FIGS. 4-8 are flow charts illustrating various embodiments of the present invention.

### DETAILED DESCRIPTION OF THE INVENTION

The present invention includes methods and systems for providing, storing and enabling access to Internet-based content. In the following detailed description, numerous specific details are set forth in order to provide a thorough understanding of the present invention. It will be apparent to one of ordinary skill in the art, however, that these specific details need not be used to practice the present invention. In other instances, well known structures, interfaces and processes have not been shown in detail to avoid unnecessarily obscuring the present invention.

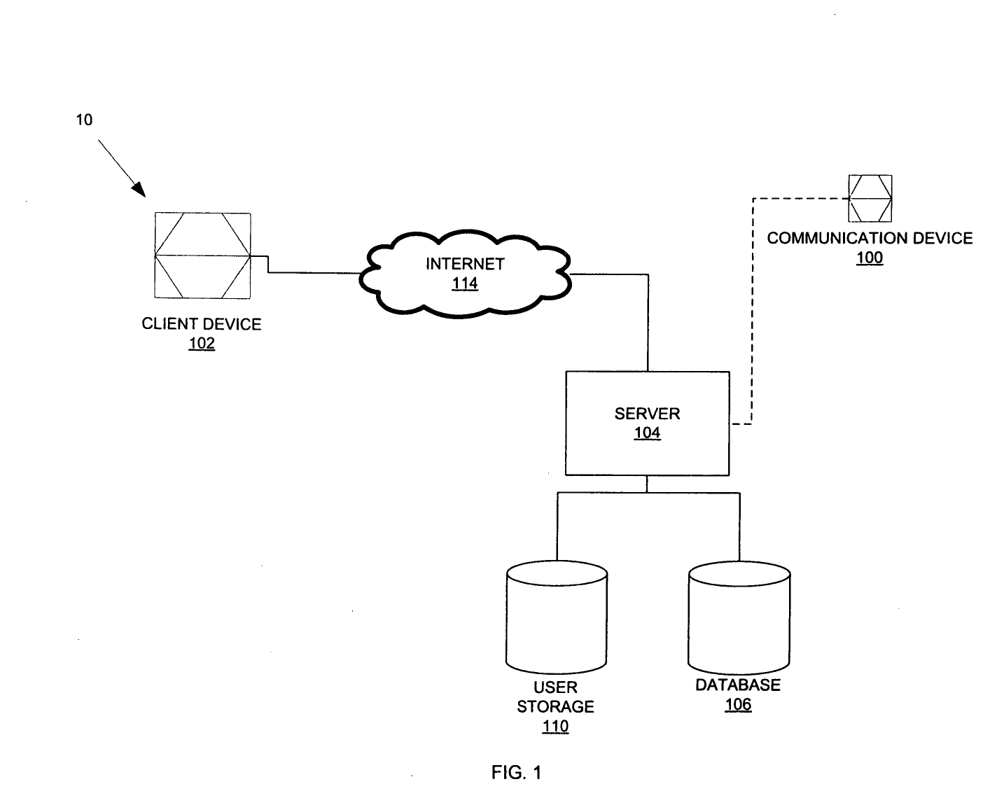

Referring to FIG. 1, the present invention includes a method of enabling requests for information.

Initially, a potential user may access a server 104 through the Internet or otherwise, as known in the art. The server 104 may prompt the potential user to register. Registration may, as known in the art, include collection of personal information about the user, including information on how the user will send information of interest, in the form of codes, to the server 104 (e.g., a text message number or telephone number associated with a cellular telephone, etc.), additional contact information (e.g., an e-mail address), and personal, or demographic, information (e.g., gender, age, income range, occupation, education, residence information, nationality, race, etc.). The server 104 may also be used to collect other information about the registering user, including information on the types of activities in which the registering user engages, the user's likes and dislikes with respect to a variety of topics, the user's spending habits, and the like. Such information may be stored in a database 106 or storage 110 associated with the server 104.

The method involves a server 104 connected to or including at least one database 106 for storing information. The server 104 is configured to receive requests for information from a user via a communication device 100. In some embodiments, the user may contact the server 104 with the communication device 100 by using a so-called “shortcode” such as a text messaging number, an e-mail address, a messaging service address, or the like, that provides access to the server. Communication devices 100 may include, but are not limited to, short message service (SMS) text messaging, enhanced message service (EMS), multimedia message service (MMS), email, instant messaging, universal code (e.g., bar code, etc.) scanners and associated software, PVR/DVR remote control devices, and interactive voice recognition applications (IVR).

The user may perceive a code in a media application and obtain information from the server 104 using the code. In some embodiments, the code may be associated with content related to the media application (e.g., products, services people, places, etc., or combinations thereof). In other embodiments, the content may not necessarily be related to the subject matter of the media application, but may be related to the origin of the code. The media application may be visual or audio. By way of non-limiting example, media applications may include movies, television, fictional plays, books, video games, magazines, exhibits, concerts, sporting events, music videos, billboards, lectures, presentations, signage, Internet content, newspapers, out-of-home advertising, and radio programs. A user may perceive a code in a media application or in association with (e.g., in television, closed-captioning, alternate language transmission signals, etc.) a media application.

In one example, as user 202 may observe something of interest in a visual media application displaying a code. Wishing to obtain information, the user 202 may transmit the code to the server 104 using a communication device 100, such as cellular telephone, conventional telephone or messaging device.

After the code is received at the server 104, the server 104 may access the database 106 to retrieve content associated with the code. The database 106 may comprise memory in which codes and, optionally, content or information (e.g., URL links) associated with codes is stored. The user identity may be resolved using indicia transmitted by the communication device 100. In various embodiments, the communication device 100 may be a mobile telephone used to transmit the code via SMS text messaging. In such an embodiment, automatic number identification (ANI) information transmitted with the text message may be used to resolve the user identity. In other embodiments, the user may transmit a personal identifier with the code to the server 104.

If the user is a registered user, the content associated with the code may be saved or stored in memory comprising the database 106 or in storage 110 allocated to the user. The storage 110 may be present on the same device (e.g., stand-alone memory, memory associated with a computer, etc.) or on a separate device that also communicates with a central device, such as the server 104. The server 104 may, optionally, transmit a response message in the form of an email and/or SMS text message confirming the request and providing direct access to content associated with the code or a link to the associated online content.

In embodiments where a user is unregistered, indicia such as the ANI or other identifying indicia that has been provided to the server 104 may be used to track the code request. The server 104 may temporarily store content associated with the code as well as content associated with the unregistered user's identifying indicia on the database 106 until the user completes registration. The server 104 may transmit a message (e.g., a text message, an e-mail message, a voice message, etc.) to the user providing information that will enable the unregistered user to register or provide access to content associated with the code. By way of non-limiting example, the server 104 may transmit a short uniform resource locator (URL) to the unregistered user enabling the user to access registration or content associated with the code. Alternatively, the user may subsequently access the server 104 and, thus, the saved or stored code information through the Internet by providing an identifier (e.g., the telephone number) of the communication device 100 that was originally used to transmit the code to the server 104. Upon accessing the server 104, and before access to any stored codes is granted, the unregistered user may be required to register for the service in a manner known in the art.

Upon registration of the user, the server 104 may permanently allocate storage 110 assigned to a single registered user. The server 104 may retrieve and store content associated with the code submitted by the single user to the storage 110. In various embodiments of systems according to the present invention, content associated with codes may be present on the same or a separate device (e.g., stand-alone memory, memory associated with a computer, etc.) as one or both of the storage 110 allocated to the registered users and the database 106. In other embodiments, content associated with the codes may be stored on one device database 106 and the storage allocated to the registered users may be stored on another database 106. Both databases 106 may be accessible via the server 104.

Access to stored codes may optionally be facilitated by sending messages (e.g., e-mails) with, but not limited to including, lists of the stored codes and links to pages that display content associated with the codes, or with links to a web page on which the stored codes and associated content or links are listed.

The registered user may access and maintain the storage 110, including, without limitation, stored codes and associated information (e.g., content, links, etc.) through a client device 102 running a client program or a web browser and connected to the server 104 (e.g., through the Internet 114). The client device 102 may be any device suitable for accessing a server 104. Devices with Internet access and an appropriate client program or web browsing capability for accessing server 104, including, but not limited to, personal computers (PCs) or laptops, mobile telephones, personal digital assistants (PDAs) or handheld PCs, may be employed in accessing the server 104.

Using the client device 102 to connect to the server 104, the registered user may access content associated with one or more codes in that user's storage 110 by logging into the account created during the registration process described above.

The code may enable the user to access content directly or indirectly related to the media application. As an example of content that is directly accessible on the server, the content associated with the code may be stored on the database 106 as elements on a webpage.

In another example, in which content may be directly accessed, indirectly accessed, or in which a combination of direct and indirect access to content may be provided, content associated with the code may be stored and provided to the user in the form of an “interstitial page.” An “interstitial page,” as used herein, refers to a page that “sits” between a referenced page and the page which it references. The interstitial page may contain links to content related to a media application or an entity connected to the media application. The interstitial page may provide additional content or may simply link directly to information associated with the code. In various embodiments, the interstitial page may contain the complete content without linking to external properties.

As yet another example, the user may access a free form entry field, into which one or more codes are entered. The free form entry field may be formatted and designed to provide direct access to content associated with each code and/or links associated with each code

In various embodiments, the registered user may maintain or manage the individual storage 110 by using the client device 102 to access the server 104 through the Internet connection 114. The user may maintain content by organizing, editing, adding, deleting, forwarding and sharing (e.g., by sending codes, links, or content; by storing codes, links or content in a publicly accessible or limited access “virtual locker”; etc.) codes and content associated with code. As the stored codes provide the user and, optionally, others continued access to content associated with codes perceived in media application, the method provides users with a means of instantly bookmarking information.

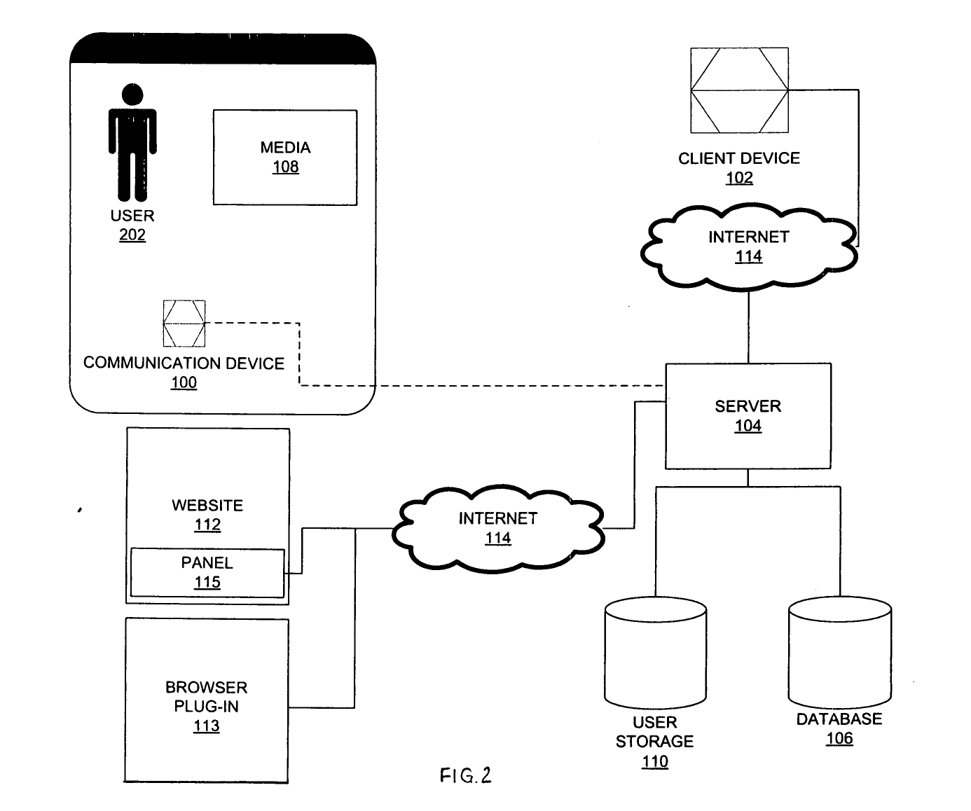

As shown in FIG. 2, a method for providing information is provided. In some embodiments, the method includes providing a code in a media application 108 such that it may be perceived by a user 202. The user 202 may perceive the code by observing the code, such as on a billboard or in association with a television program, or may perceive the code by hearing the code, such as in a radio program.

Upon perceiving the code, the user 202 may wish to immediately store a request for content associated with the code for later retrieval, without having to discontinue or disrupt ongoing activities (e.g., watching a television program, travel, etc.) by using a web-enabled client device 102 (FIG. 1). Saving or storage of the code may enable the user to subsequently request such content by allowing the user 202 to quickly and briefly contact a server 104 configured to store codes and/or content associated with codes. The user 202 may contact the server 104 using a communication device 100. For example, upon or subsequent to perceiving a code (e.g., viewing a code displayed in a television program, on a billboard, etc., or hearing a code), the user 202 may use a specific shortcode to access the server 104, then transmit the code to the server 104, such as by SMS text messaging on a cellular telephone.

Upon receiving the code, the server 104 may save or store the code in association with the user's profile, if the user has previously registered, or in association with a temporary identifier, if an unregistered user has sent the code. Optionally, the code may be processed in order to provide the user with content associated with the code. In some embodiments, the server 104 may save or store the code in the storage 110.

In some embodiments, the server 104 may send a confirmation or reminder (e.g., in the form of an e-mail) to the user 202 that the code has been received. The confirmation or reminder may enable the user to access content associated with the code. In one example, the confirmation or reminder may contain information (e.g., a URL, URL link, etc.) enabling the user to link to the server 104 or directly to a media partner's website 112, which may be configured to interact with the server 104 in the manner described in reference to FIG. 1. As another example, the confirmation or reminder may provide links to content associated with each code perceived by a particular user that has been sent to and received by the server 104 and stored in storage 110. Again, such content may be accessed directly from the server 104 or through the website 112 of a media partner.

Alternatively, the server 104 may more passively facilitate subsequent access by the user to one or more codes and associated content by merely allowing a registered user to log in and access stored information without any prompting. The server 104 may provide the user 202 with access to stored codes, as well as the ability to maintain the codes and, optionally, share, rate, comment, and view additional codes. The server 104 may also provide the user 202 with access to code-based content related to the media application 108, such as in the manner described above in reference to FIG. 1.

As another example, the server 104, in conjunction with a code saved or stored thereon, may provide a registered user with access to an “external” website 112 that displays content associated with one or more of the saved or stored codes. The website 112 may be maintained by a media partner that provides content associated with the code. Through interaction with the server 104, the website 112 may enable the user 202 to view content while maintaining access features provided by the server 104. The website 112 may be displayed in a panel 115 or browser plug-in 113 in the web site hosted by the server 104, or a panel or a plug-in may be configured to provide the user with access to features on the server 104 while the user views the separately hosted (e.g., by another server) website 112.

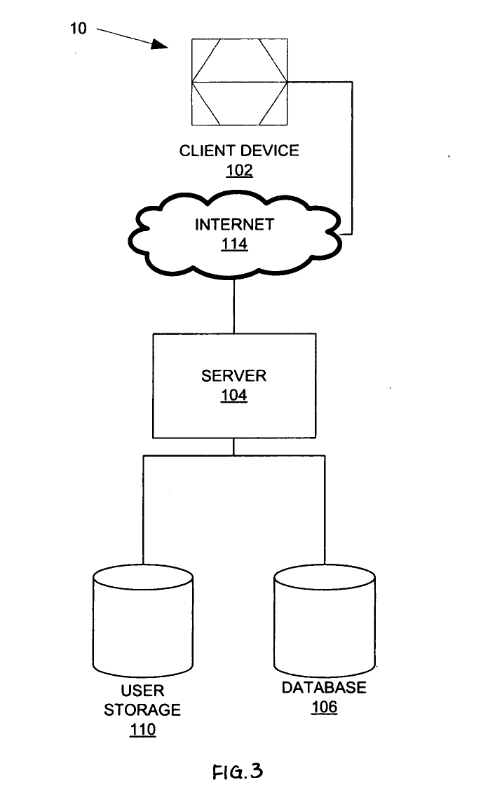

Referring to FIG. 3, and with additional reference to FIGS. 1 and 2, a system 10 for providing information to a user is illustrated. The system 10 includes at least one client device 102, a database 106 and a server 104 interconnecting the client device 102 and the database 106 and storage 110, as well as content associated with one or more of a particular user's codes that have been saved in storage 110. Each of these components of the system 10 may operate in the manner described above in reference to FIGS. 1 and 2.

The client device 102 may be any device suitable for accessing the server 104, such as PCs, laptops, mobile telephones, PDAs or handheld PCs, with appropriate communication capabilities (e.g., Internet access, client program or web browsing capabilities, etc.). The client device 102 provides a user with access to the server 104 which, in turn, communicates with the database 106 and virtual storage 110.

In various embodiments, the database 106 or the storage 110 may store interstitial pages that include content associated with a code. Thus, each user may store and access content associated with a plurality codes by the methods described herein.

As described, the server 104 provides a communicative link between a communication device 100 and the storage 110, as well as between a client device 102 and both the database 106 and the storage 110. The server 104 also allocates the storage 110 to the user. In some embodiments, the storage 110 is allocated to the user upon registration using the client device 102. Additional storage may be allocated with repeated use, upon request (and optional additional payment) by a user, or otherwise.

The server 104 also receives a code transmitted by a user with a communication device 100 and retrieves content associated with the code from the database 106. In embodiments where the user is a registered user, the server 104 may recognize the user through parameters sent from an SMS gateway or with other manually input or automatically transmitted identifying indicia (e.g., a user name or number and, optionally, a password, etc.). Upon receipt of a code, the server 104 may retrieve content and store the retrieved content in the storage 110 allocated to the registered user, or the server 104 may store a link to content that corresponds to a code that has been received from the registered user. Thereafter, the registered user may access the storage 110 by connecting to the server 104 using the client device 102. The database 106 or storage 110 may store and, optionally, update account information (e.g., personal or demographic information, information on regarding a user's likes and/or dislikes, information on the types of media viewed by the user, etc.) specific to the user as well as all codes requested and stored by the user.

Where the user has not registered, the server 104 may retrieve the content associated with the code and temporarily store the code request information, as well as information indicative of the unregistered user, in the storage 110. When the user registers, the server 104 may allocate storage 110 to the registered user and may update the user account with information previously stored using the uniquely identifiable user information collected prior to registration.

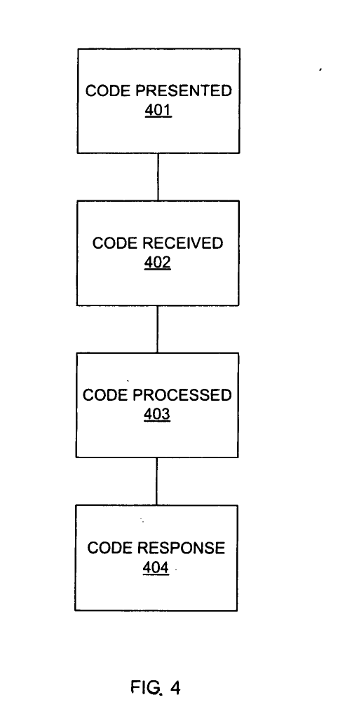

Referring to FIG. 4, a method of providing information is illustrated. The method includes displaying a code using a media application, receiving the code, processing the code, and transmitting information to a user. The transmitted information allows the user to access content related to the media application. In certain embodiments, the receiving, processing and transmitting steps are coordinated by a server such that the steps are automatically performed upon submission of the code by the user. As an example, the user is interested in a product associated with the visual media and the second code directly or indirectly enables the user to purchase the product. In some embodiments, the information transmitted to the user may be, for example, another code providing access to information, a short URL, instructions, confirmation, or an interstitial page.

The method may be applicable to a variety of media applications including, but not limited to, movies, television, fictional plays, books, video games, magazines, exhibits, concerts, sporting events, music videos, billboards, signage, Internet files and radio programming. In one example, the method can be used with a television broadcast to provide program specific information regarding products such as clothing, sporting goods, cosmetics, jewelry and accessories. The method is may be useful in assisting viewers of visual media in obtaining product information about items that lack identifiable features such as a logo, trademark, trade dress or other feature.

The present invention may take a variety of forms regardless of the type of media application, communication device, or client device. For example, FIG. 4 is a flow diagram generally illustrating a method for presenting, receiving, and processing codes in accordance with teachings of the present invention. Generally, a code is presented 401 using a visual or audio media application. The code may be perceived by a user when the user views or hears the code presented though the medial application. The user may transmit the code to the server to request relevant information. The code is received 402 and processed 403 by the server. Based on the code, information may be transmitted 404 back to the user. The information allows the user to access content relevant to the media application used to present the code. In some embodiments, the information enables the user to access, for example, a means for purchasing products displayed on the media application (e.g., a website or webpage from which the products may be purchased, a list with links to one or more such websites or webpages, etc.).

The information associated with a code may further link the user to an external content source, such as a webpage containing relevant information. Requests may also be tracked. The method may also include tracking user exits to external webpages. A customer account may optionally be charged (e.g., a monthly fee, on a cost-per request basis, etc.). The customer account may optionally be charged on a “cost-per-click” basis (i.e., based on the number of times content is initially viewed, based on the total number of times content is viewed, etc.).

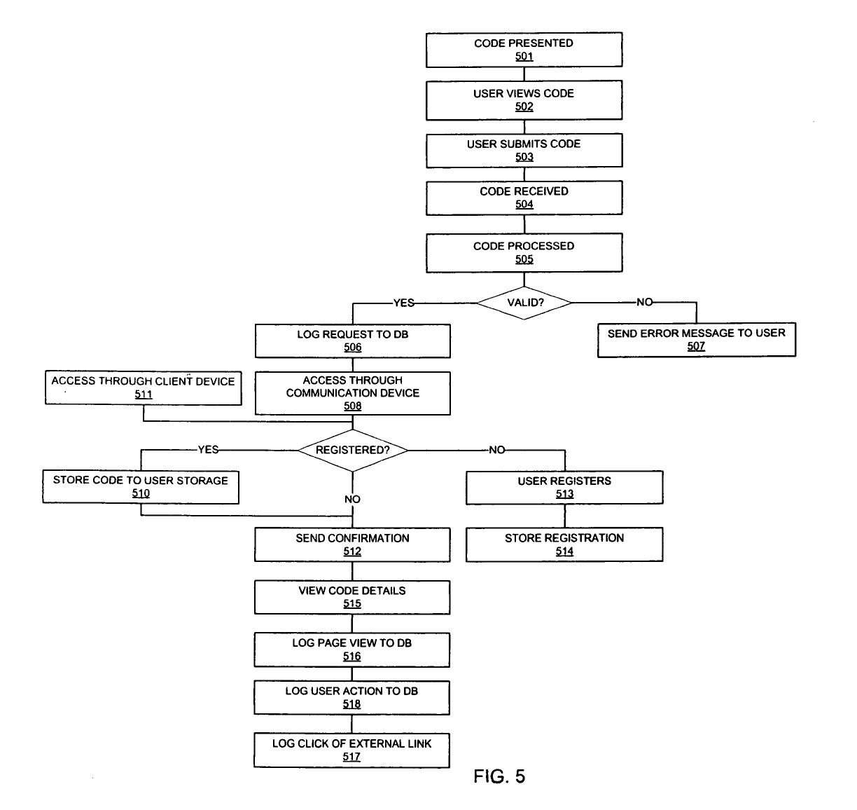

FIG. 5 is a flow diagram illustrating a more specific and detailed embodiment of a method of the present invention. A first code is displayed 501 within a visual media. A user wishing to obtain information relevant to the visual media views 502 the code and transmits 503 the code to a content server. The content server receives 504 and processes 505 the code using information stored in a database. Where the code is valid, a request is logged 506 to the database. Alternatively, if the code is an invalid code, the content server will transmit 507 and error message to the user.

A query 507 determines whether or not the user who sent the code is registered. If the user is registered, information associated with the code is stored in storage allocated 510 to the user. In the event the user accesses the server through a client device, the identity of the user and, thus, the registered user's account may be resolved with account login information. In the event that a user transmits a code through a communication device, the user account may be resolved using unique information associated with the user, which may be automatically provided as the code is input, or entered by the user with the code or codes that are transmitted to the server. In some embodiments, the SMS text message request will contain the automatic number identification (ANI) information. The user account may be resolved using this information.

The user may receive a response, or confirmation, message in the form of an e-mail and/or SMS text message confirming the request and providing a link to the associated online content.

If a user is not registered, the request is tracked along with a unique identifying indicator, such as the ANI or unique identifying information input by the unregistered user. Another code may be transmitted 512 (e.g., by text message, e-mail provided that an e-mail address has been provided to the server, etc.) to the unregistered user providing a short URL to gain access to the content associated with each transmitted code. The user may be required to register before obtaining access to the content.

Once the user registers, their requested codes will be associated with their account. Where the user opts to register, the user's registration information is stored 514 and may be subsequently updated based on codes that are saved and activities that are conducted through the server. The registered user may access 515 content associated with the code and, thus, related to the media application perceived by the user and with which the code was associated.

Alternatively, a user may be permitted to bypass registration and still obtain access 515 to content associated with one or more codes.

The content server logs 511, or stores, user behavior on the basis of an ANI or caller identity display (CID) or other user-identifying information (whether or not the user is registered). Such user behavior may be based upon the code or codes that are transmitted by a user, a timestamp of when such transmission occurred, and a variety of other information, including a user's activities in connection with one or more transmitted and stored codes. For example, the websites or webpages viewed by the user may be logged 516. In certain embodiments, the user may click on external links 517 associated with a code, the details of such user actions may also be logged 518.

In some embodiments, the server may transmit the message back to the user through a variety of means that would be recognize by one of skill in the art. For example, a message (e.g., an e-mail message, a voice message, text message, instant message, multimedia message, etc.) including information relevant to the perceived media associated with a transmitted code (e.g., a URL link, etc.) may be sent to the user (e.g., via internet, a cellular telephone, SMS, EMS, MMS, DVR/PVR system, instant messaging service, image recognition, etc.).

### EXAMPLES

### Example 1

A code (e.g., “code”) may be displayed in connection with a television program such that a registered user may see “code” on the screen. To obtain information associated with the television program, a user may use any device with text messaging, such as a cellular telephone, to send “code” to the shortcode for the server (e.g., “59479”). The text message containing “code” is received and processed by the server. The server identifies the registered user based on the indicia provided during registration and stores information associated with “code” in storage allocated to the registered user. Optionally, the server sends a reply to the text messaging device confirming receipt of the text message and/or providing instructions to the user for accessing the information associated with “code.”

The registered user may log into the individual storage to view information associated with “code.” The individual storage containing information associated with “code” may be accessed at a specific URL (e.g., www.kwiry.com). By logging in, the user may maintain or manage the individual virtual storage by adding, deleting, forwarding, organizing, and sharing stored codes, including “code.” For example, the user may mark a code as public, allowing other users to view their virtual storage locker and all codes that have been saved in that locker. In the alternative, the user may hide codes, or prevent codes or associated content from being publicly displayed.

The server may additionally transmit an SMS text message containing a short URL that a registered or unregistered user may enter into a web browser. An example of the format for this short URL is www.kwiry.com/<code>. The user may access information associated with the code by entering the short URL into a web browser.

### Example 2

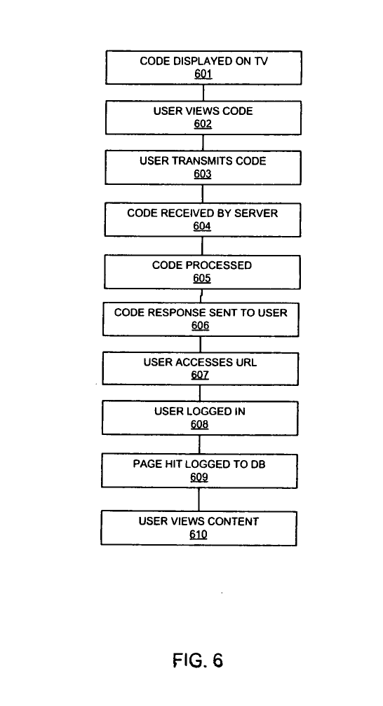

As shown in FIG. 6, a code may be displayed 601 during a television broadcast. A registered user views 602 the code and wishes to obtain information relevant to the television broadcast. The user transmits 603 the code using SMS text messaging. The code is received 604 by a content server. The user is logged into 605 a database stored on the content server. The code is processed 606 by the content server using information stored in the database. The content server transmits 607 containing a URL to the user. The user accesses 608 the URL and is logged in 609 to the database. The URL page “hit” is logged 610 to the database. The user views 611 products relevant to the television program. The products requests are logged 612 to the database.

The information accessed by the user may be useful in producing and storing tracking information. Specifically, information logged to the database, such as user information, page hits and product hits, may be useful in tracking marketing information. Such information may be useful in the generation of tracking reports based on the users. These reports include, but are not limited to, users watching live television by shows, user gender by account, user gender by product, user gender by brand, location by account, location by product, location by brand, age groups, user interests, requests per episode, requests per product, average number of screens viewed per session, average number of products viewed per session, average duration of session, percentage of repeat visitors, average revenue per episode, average revenue per season, top product requests, top brand requests, top actors viewed, top shows viewed, and a variety of other information.

Information pertaining to the codes, including, but not limited to the following: shows, season number, episode number, scene number, actor name, character name, brand names, brand URLs, vendor names, vendor URLs, product description, account information, code request tracking, product request tracking, etc, may be stored on a database within the content server. Stored information may be useful in delivery of information to the user.

### Example 3

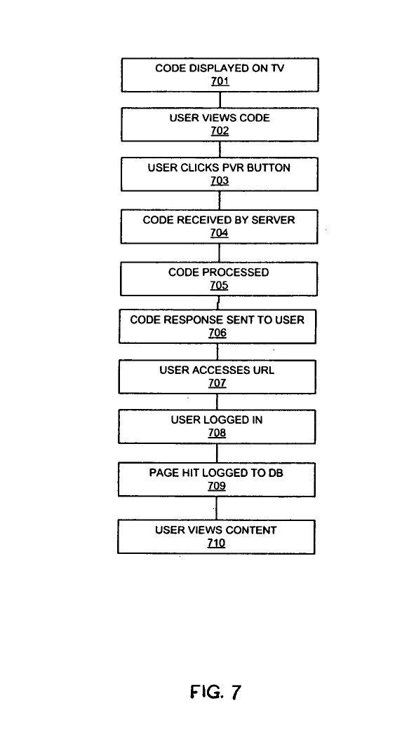

The user may obtain information relevant to a television program using a PVR remote, as shown in FIG. 7. A PVR button is programmed to connect to the content server. A code is displayed 701 during a television program. A user viewing the television program and wishing to obtain information relevant to the television broadcast clicks 703 the PVR hardware button. The PVR sends 704 a request to a content server. The content server processes 705 the PVR request. A message is sent 706 to the user through the PVR, providing the user with information that will enable the user to access 707 information relevant to the content of the television broadcast.

### Example 4

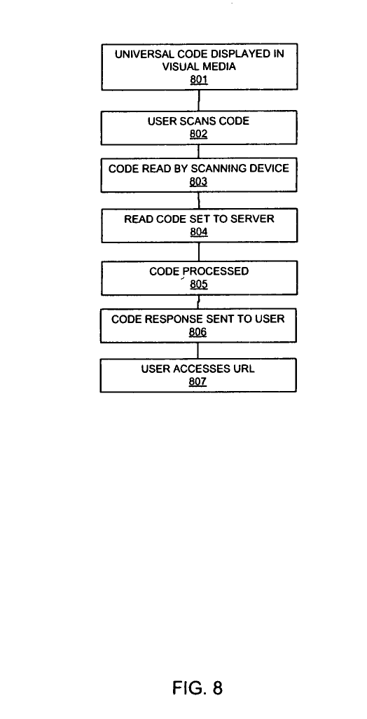

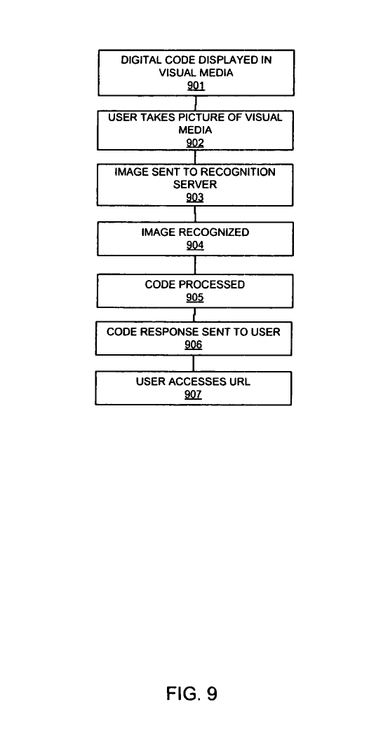

A digital universal code scanner may be used to provide a user with information, as shown in FIG. 8. A digital universal code is displayed 801 with a visual media. A user wishing to obtain information relevant to the visual media scans 802 the digital universal code using a scanning device such as digital code scanning software installed on a cellular telephone. The digital universal code is read 803 by the scanning device and is transmitted 804 to a content server by the user. The code is processed 805 by the content server. The content server will transmit 806 a message to the user based on contact information stored in the database. The message enable 807 the user to access information relevant to the visual media.

### Example 5

Referring to FIG. 9, imaging may be used to provide a user with information using image recognition. The image recognition server is configured to recognize an image. In some instances, the image contains a digital code presented in a visual media 901 such as those known in the art and described herein. In other instances, the image may act as the digital code upon recognition by the server. Additionally, the server may store codes associated with the image for transmission to the user. Wishing to obtain information about the image, such as a magazine ad or television program, a user captures the image 902 using an imaging device such as a camera. The user transmits the captured image containing the digital code to a recognition server 903 using a communication device with imaging capabilities. The recognition server recognizes the image 904 and processes the image or digital code 905 to access information relevant to the image. The recognition server sends a response to the user 906 containing a URL. The user accesses the URL 907 to obtain information relevant to the digital code displayed in the image 901.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for providing access to information, comprising:
disseminating codes associated with media content;
receiving at least one code from at least one user who transmits the at least one code at or near a point of transmission at which the at least one user perceives the at least one code, regardless of whether the at least one user has access to additional information about the media content at the point of transmission;
storing the at least one codes in association with an identifier associated with a user who has transmitted the at least one code;
retreiving additional information associated with the at least one code; and
providing the user with subsequent on-line access to the additional information.

2. The method of claim 1, wherein receiving the at least one code comprises receiving a text message containing the at least one code.

3. The method of claim 1, wherein receiving the at least one code comprises receiving and internet-based request containing the at least one code.

4. The method of claim 1, wherein retreiving additional information comprises retreiving or generating at least one interstitial page associated with the at least one code, the at least one interstitial page enabling the user to link to content related to the at least one code.

5. The method of claim 1, wherein retreiving additional information comprises placing the information on at least one interstitial page for access by the user.

6. The method of claim 1, wherein retreiving information associated with the at least one code comprises retreiving links to a website maintained by a source providing the code.

7. The method of claim 1, wherein receiving the at least one code perceived by the user at the server comprises recieveing at least one code from a text message.

8. The method of claim 1, wherein receiving the at least one code perceived by the user at the server comprises receiving at least one code from an Internet-based request.

9. The method of claim 1, wherein providing the user with access to the individual storage comprises internet-based access to storage allocated to the registered user.

10. The method of claim 1, wherein providing the user with access to the individual storage comprises enabling the user to maintain the at least one code in the individual storage.

11. The method of claim 1, further comprising:
enabling the user to share information with another user.

12. A method of providing information comprising:
providing a code in a media application, the code associated with content related to the media application, the content stored on a database;
receiving the code transmitted by a user with a communication device;
processing the code to retrieve content related to the media application; and
providing the user with access to content related to the media application, the user accessing the content using a communication device.

13. The method of claim 12, wherein providing access to content related to the media application comprises transmitting a message to the user based on the code, the message allowing access to content related to the media application.

14. The method of claim 12, wherein providing a code in a media application, the code associated with content related to the media application, the content stored on a database comprises maintaining a database of interstitial pages containing content related to the media application.

15. The method of claim 12, further comprising:
storing content related to the code received from the user on the database.

16. The method of claim 12, further comprising:
transmitting a message to the user allowing providing instruction or allowing the user to access information on the database

17. The method of claim 12, wherein providing the code comprises displaying the code on a visual media where it is viewable by the user.

18. The method of claim 12, wherein providing the code comprises broadcasting audio.

19. The method of claim 12, wherein receiving the code transmitted by a user comprises receiving a text message containing the code.

20. The method of claim 12, wherein receiving the code transmitted by a user comprises receiving and internet-based request.

21. The method of claim 12, wherein the receiving the code transmitted by a user, the user having access to the database through a communication device comprises receiving the code transmitted by a user, the user accessing the database through a mobile phone.

22. The method of claim 12, wherein the receiving the code transmitted by a user, the user having access to the database through a communication device comprises receiving the code transmitted by a user, the user accessing the database through an Internet connection.

23. A system for providing information comprising:
at least one communication device for transmitting at least one code to a server;
a server configured to receive data, including the at least code;
at least one database in communication with the server, including at least one network-based storage allocated to a registered user by the server, and containing at least one interstitial page associated with at least one code; and
at least one client device configured to access a network-based storage containing at least one code, the at least one code enabling the at least one client device to retrieve at least one interstitial page associated with the at least one code.

24. The system of claim 23, wherein the interstitial page comprises at least one URL that enables the user to access a website.

25. The system of claim 23, wherein the server stores a plurality of codes in the individual storage.

26. The system of claim 25, wherein the plurality of codes in the individual storage provides access to information associated with the code.

27. The system of claim 25, wherein the server enables the user to maintain the plurality of codes within the storage allocated to the user.
